(19) United States
(12) Patent Application Publication
(10) Pub. No.: US 2018/0024609 A1
(43) Pub. Date: Jan. 25, 2018

(54) BACKUP POWER COMMUNICATION

(71) Applicant: Hewlett Packard Enterprise Development LP, Houston, TX (US)

(72) Inventors: Matthew T. Bolt, Houston, TX (US); Patrick M. Schoeller, Cypress, TX (US); Patrick A. Raymond, Houston, TX (US); David Kimler Altobelli, Houston, TX (US)

(21) Appl. No.: 15/532,841

(22) PCT Filed: Dec. 2, 2014
(86) PCT No.: PCT/US2014/068239

§ 371 Date: Jun. 2, 2017

(51) Int. Cl. G06F 1/30; G06F 13/42; G06F 1/26; G06F 1/32

(52) U.S. Cl. CPC G06F 1/305; G06F 1/3287; G06F 13/4282; G06F 1/263; H04L 67/104

(57) ABSTRACT

Example implementations relate to backup power communication. For example, a system includes a shared backup power supply coupled to a node, where the shared backup power supply includes a first communication interface. The system also includes a plurality of loads supported by the node, where each load of the plurality of loads includes a second communication interface. The first and second communication interfaces support peer-to-peer (P2P) communication between the shared backup power supply and the plurality of loads.

### BACKGROUND

As reliance on computing systems continues to grow, so too does the demand for reliable power systems and backup schemes for these computing systems. Servers, for example, may provide architectures for backing up data to flash or persistent memory as well as backup power sources for powering this backup of data after an interruption of power.

### BRIEF DESCRIPTION OF THE DRAWINGS

Some examples of the present application are described with respect to the following figures:

FIG. 1 is a block diagram of a system including a shared backup power supply that communicates with a plurality of loads via peer-to-peer (P2P) communication, according to an example;

FIG. 2 is a block diagram of a system including a shared backup power supply that communicates with a plurality of loads via P2P communication, according to an example;

FIG. 3 is a block diagram of a system including a shared backup power supply that communicates with a plurality of loads via P2P communication, according to an example; and

FIG. 4 is a block diagram of a computer-readable storage medium having instructions executable by a processor to facilitate P2P communication between a shared backup power supply and a plurality of loads, according to an example.

### DETAILED DESCRIPTION

A computing and/or data storage system can include a number of nodes. The nodes can be components of the computing and/or data storage system. For example, the nodes can include a server, a chassis of servers, a rack of servers, a group of servers, etc. A node can support a plurality of loads. For example, a load can include cache memory, dual in-line memory modules (DIMMs), non-volatile dual in-line memory modules (NVDIMMs), and/or array control logic, among other storage controllers and/or devices.

An interruption of a primary power supply can be scheduled or un-scheduled. For instance, a scheduled interruption of the primary power supply can be the result of scheduled maintenance on the device and/or a number of loads. An un-scheduled primary power supply interruption can be an interruption in the primary power supply. An un-scheduled primary power supply interruption cart occur when, for example, the primary power supply fails momentarily or for an extended period of time. Failure can include unintentional loss of power to devices and/or loads from the primary power supply.

A secondary power supply can be used to provide backup power to the loads during interruption of the primary power supply, for example, for moving data from volatile or cache memory to non-volatile memory. The backup power supply can be shared by the plurality of loads (i.e., to receive backup power during interruption of primary power). Thus, backup power supply is a shared backup power supply, in that the shared backup power supply associated with a particular node is shared among a plurality of loads associated with that node. Interruption of a primary power supply can refer to a power failure, power surge, inadequate power, and/or transient faults. A backup power supply can provide near-instantaneous protection from power interruption by supplying energy stored in batteries, super capacitors, or flywheels, among others.

To supply backup power, the backup power supply may need to communicate with the plurality of loads to exchange information such as status and activity information. Current solutions for communicating among devices of a node include transferring information over multiple communication protocols and devices with extra processing within all relaying (or intermediary) devices. For example, for a backup power supply to send battery status information to a plurality of storage devices, the information is first communicated via an inter-integrated (I2C) interface to a baseboard management controller (BMC). The BMC then processes the information and send it via platform environment control interface (PECI) to a central processing unit (CPU). The CPU then processes the information and sends it to the storage devices over a peripheral component interconnect express (PCIe) interface. In such an example, communication between the backup power supply and the loads involve using the BMC as a master device and the shared backup power supply and loads as target/slave devices.

Examples disclosed herein address the above needs and challenges by providing a peer-to-peer (P2P) communication solution between the backup power supply and the plurality of loads, thereby reducing latencies. Further, by implementing P2P communication between the backup power supply and the loads, processing steps and translations that may burden resources and devices of the node (e.g., the BMC) may be significantly reduced. Examples disclosed herein provide P2P communication that enables the backup power supply to communicate directly with the plurality of loads, and also enables the plurality of loads to communicate directly amongst themselves. Enabling such direct communication using P2P communication protocols allows for more efficient handling of communication between the backup power supply and the plurality of loads, as well as decreased time to configure the backup power supply to provide backup power to the plurality of loads.

As used herein, a P2P communication protocol refers to an environment, such as a server environment, where devices can communicate directly with each other, eliminating a master-slave configuration that uses one or more centralized access points for coordination of the communication.

In one example, a system includes a shared backup power supply coupled to a node, where the shared backup power supply includes a first communication interface. The system also includes a plurality of loads supported by the node, where each load of the plurality of loads includes a second communication interface. The first and second communication interfaces support peer-to-peer (P2P) communication between the shared backup power supply and the plurality of loads.

In another example, a system includes a shared backup power supply to provide backup power to a plurality of loads of a node, where the shared backup power supply includes a control module that includes a first communication interface. The system also includes an array controller coupled to the plurality of loads, the array controller to manage the plurality of loads and where the array controller includes a second communication interface. The first and second communication interfaces support peer-to-peer (P2P) communication between the shared backup power supply and the plurality of loads.

In another example, a non-transitory machine-readable storage medium is encoded with instructions executable by a processor to send a request from a shared backup power supply to a plurality of loads of a node using peer-to-peer (P2P) communication protocol. The instructions are executable by the processor to receive, by the shared backup power supply, a response from the plurality of loads using the P2P communication protocol. The response identifies a subset of the plurality of loads that are to be protected by the shared backup power supply.

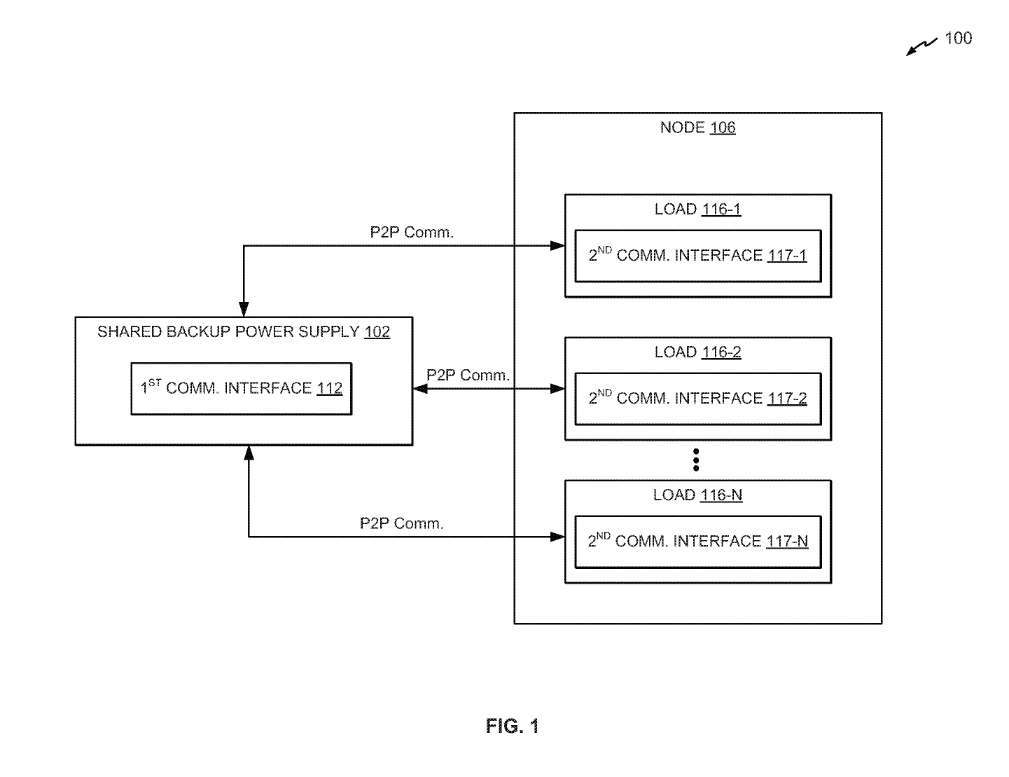

Referring now to the figures, FIG. 1 is a block diagram of a system including a shared backup power supply that communicates with a plurality of loads via peer-to-peer (P2P) communication, according to an example. System 100 can include a node 106 (e.g., a server node) and a shared backup power supply 102. As illustrated in FIG. 1, the node 106 can support a plurality of loads (e.g., load 116-1, load 116-2, . . . , load 116-N, collectively referred to herein as load 116). For instance, the node 106 can support a plurality of storage controllers and/or devices such as DIMMs and NVDIMMs, network interface controllers (NIC), array controllers (e.g., smart array controllers (SAC)), video card, processing resources, and the like.

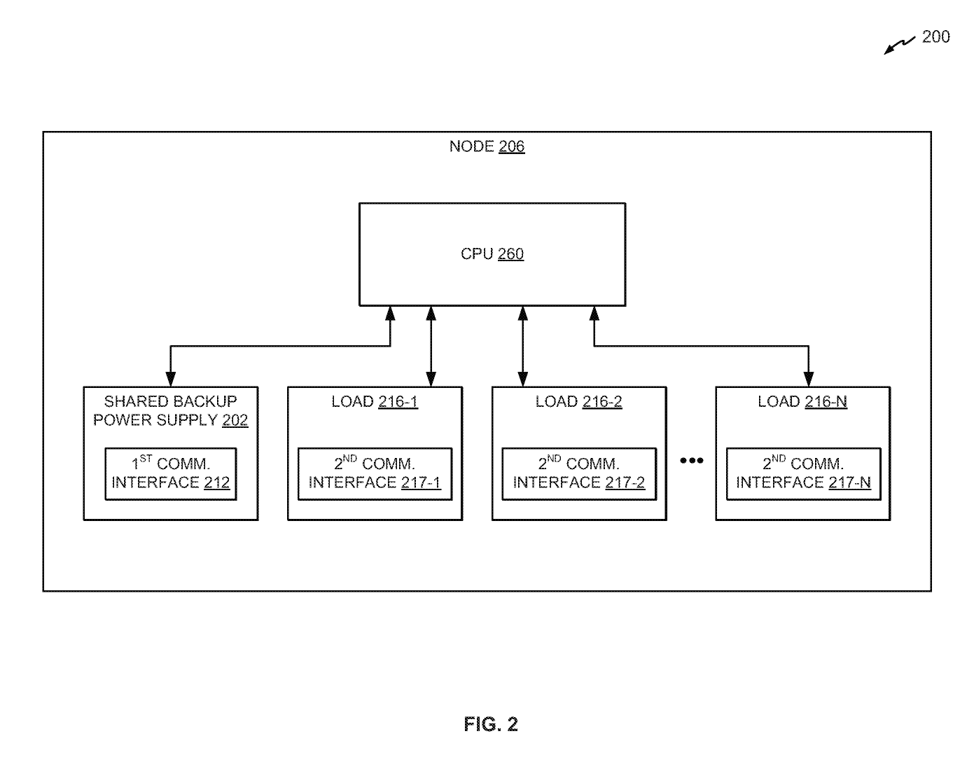

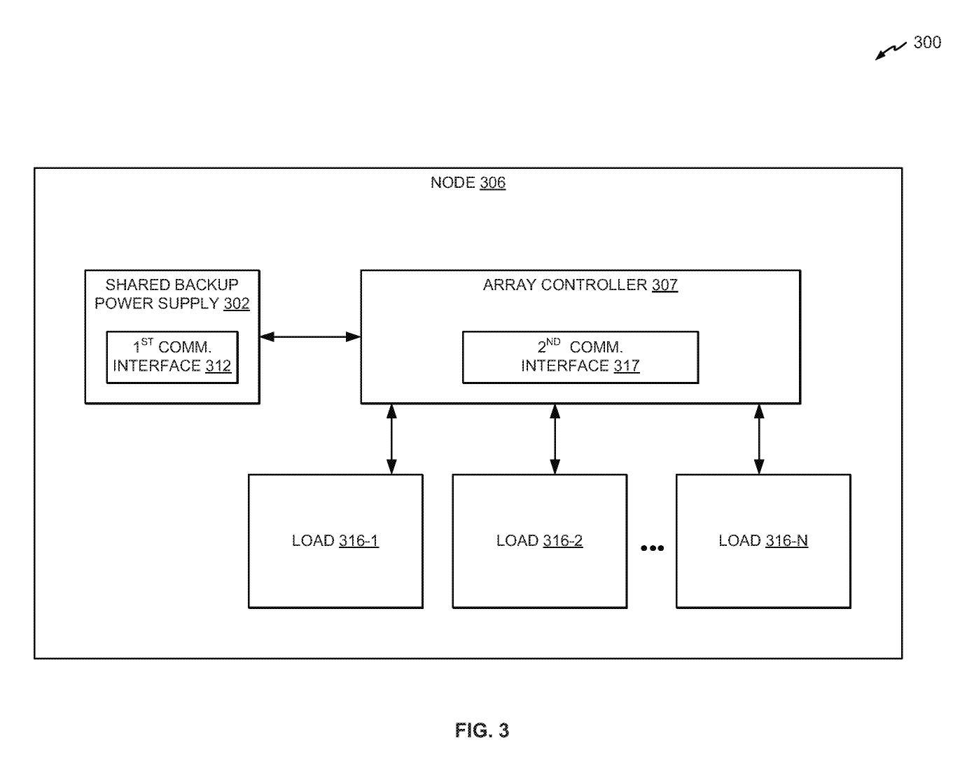

Shared backup power supply 102 can be/include an energy component to covert stored energy to electrical energy to deliver power to the loads 116 of the node 106. Examples of the shared backup power supply 102 can include, but are not limited to, a rechargeable battery, a capacitor (e.g., supercapacitor, ultracapacitor, etc.), a flywheel, and the like. While FIG. 1 illustrates the shared backup power supply 102 as a separate component from the node 106, examples are not so limited. For example, shared backup power supply can be power supply that is an integrated component of the node 106 (e.g., FIGS. 2-3) and is used to provide backup power to the node 106, such as power for transferring data from a volatile memory of the node 106 to non-volatile memory of the node 106 when a primary power supply of the node 106 is interrupted. Primary power supply can include an alternating current (AC) power supply such as voltage from a wall outlet (mains supply) that is lowered to a desired voltage.

Shared backup power supply 102 can include a first communication interface 112 to enable communication with the loads 116. Loads 116 can each include a second communication interface 117 (e.g., second communication interface 117-1 of load 116-1, second communication interface 117-2 of load 116-2, . . . , second communication interface 117-N of load 116-N, collectively referred to as second communication interface 117). The first communication interface 112 and the second communication interface 117 is to support peer-to-peer (P2P) communication between the shared backup power supply 102 and the plurality of loads 116, and P2P communication amongst the plurality of loads 116. In some examples, the first communication interface 112 and the second communication interface 117 are peripheral component interconnect express (PCIe) interfaces to support P2P communication. It should be noted however that first communication interface 112 and second communication interface 117 can be any other interface that supports P2P communication.

Enabling the shared backup power supply 102 to communicate directly with the loads 116, instead of communication over multiple protocols and devices that may require multiple processing steps, allows for more efficient handling of error communication between the shared backup power supply 102 and the loads, as well as decreased latencies, and reduce interdependencies and burdens on other devices such as a baseboard management controller (BMC). Communication between the shared backup power supply 102 and the loads can include status and activity information. For example, data communication between the shared backup power supply 102 and the loads 116 cart include data related to configuration and set up of the shared backup power supply 102 and the loads 116, discovery of the loads 116, level of power stored in the shared backup power supply 102, subset of the loads 116 that can be supported by the shared backup power supply 102 (e.g., based on the power level), setup and management of the loads 116 (e.g., a sequence in which backup power is to be provided to the loads 116), power required by each load 116 (e.g., 4 W, 60 W, etc.), an amount of power for backup procedures per a unit of time (e.g., in Joules), and so on.

In some examples, shared backup power supply 102 can include a controller (not shown) that includes the first communication interface 112. Similarly, the loads 116 can each include a controller that includes the second communication interface 117, in certain examples, node 106 can include a CPU to route the communication between the shared backup power supply 102 and the loads 116 (e.g., FIG. 2). In such an example (e.g., where the first communication interface 112 and the second communication interface 117 are PCIe interfaces), the shared backup power supply 102 and the loads 116 can be connected to the CPU's root port so that P2P communication between any of the devices can be supported.

FIG. 2 is a block diagram of a system including a shared backup power supply that communicates with a plurality of loads via P2P communication, according to an example. System 200 includes the shared backup power supply 202, the loads 216, and a CPU 260. As illustrated in Ha 2, the node 206 can host a plurality of loads (e.g., loads 216-1, 216-2, . . . , 216-N, collectively referred to herein as loads 216). For instance, the loads 216 can be DIMMS, cache memory, NVDIMMs, storage controllers, array control logic, among other devices.

Providing backup power for moving data from volatile memory to non-volatile memory may include providing the node 206 with a shared backup power supply, rather than providing a backup power supply for each load within the node 106. That is, node 106 containing a number of loads 216 can be provided with shard backup power supply 202 instead of, for example, providing a dedicated backup power supply for each load within the node 106 and therefore a single node could contain a plurality of backup power supplies. Accordingly, shared backup power supply 102 can provide temporary source of power, for a threshold of time, to loads 216 associated with the node 106 when the primary power supply is interrupted (e.g., fails). Shared backup power supply 102 can reside in a slot of the node 106 (e.g., be physically and/or directly plugged into a slot of the node 106). Accordingly, the shared backup power supply 102 can protect hardware and components of the system, such as a processing resource (e.g., system central processing unit (CPU) and various systems from data loss in response to the primary power supply interruption.

Shared backup power supply 202 can include a first communication interface 212. Similarly, each of the loads 216 can include a second communication interface 217. First communication interface 212 and second communication interface 217 can support P2P communication between the shared backup power supply 202 and the loads 216. Further, second communication interface 217 can support P2P communication between the loads 216. In certain examples, first communication interface 212 and second communication interface 217 can be PCIe interfaces or any other interface that can support P2P communication or implements a P2P communication protocol.

In the example of FIG. 2, node 206 includes CPU 260. In some examples, the CPU 260 operates as the centralized controller to receive communications from the shared backup power supply 202 and the loads 216. Thus, the CPU 260 supports P2P communication among the devices 212, 216 and routes the P2P communication accordingly. In certain examples, the shared backup power supply 202 and the loads 216 are connected (via P2P connection) to the CPU 260 (e.g., to a root port of the CPU 260). For example, by connecting to the root port of the CPU 260, all communication paths may be hardware related, thus eliminating processing and translation steps. The CPU 260 can route communications between the shared backup power supply 202 and the loads 216. Such communication can include status and activity information of the shared backup power supply 202 and the loads 216. Further, updates can be easily implemented at the shared backup power supply 202 and the loads 216.

FIG. 3 is a block diagram of a system including a shared backup power supply that communicates with a plurality of loads via P2P communication, according to an example. System 300 includes the shared backup power supply 302, the load 316, and an array controller 307. As illustrated in FIG. 3, node 306 can host a plurality of loads (e.g., loads 316-1, 316-2, . . . , 316-N, collectively referred to herein as loads 316). Loads 316 can include storage devices such as DIMMs and NVDIMMs, among other devices.

Array controller 307 (e.g., storage array controller) can be a device which manages data storage among physical disk drives within the node 306 (e.g., loads 316). In some examples, array controller 307 can be a smart array controller. Array controller 307 includes a second communication interface 317 for communicating with a first communication interface 312 of the shared backup power supply 302. First communication interface 312 and second communication interface 317 support P2P communication between the shared backup power supply 302 and the loads 316 managed by the array controller 307. Accordingly, the loads 316 can reside behind the array controller 307 that includes the second communication interface 317 to support P2P communication. In certain examples, first communication interface 312 and second communication interface 317 can be PCIe interfaces or any other interface that can support P2P communication or implements a P2P communication protocol.

In certain examples, P2P communication between the shared backup power supply 302 and the array controller 307 can be routed via a CPU of the node 306. In such an example, the shared backup power supply 302 and the array controller 307 can be coupled to a node of the CPU to support P2P communication. The communication can include status and activity data of the shared backup power supply 302 and the loads 316. For example, the communication can include identification of the loads 316 to be protected by the shared backup power supply 302, information pertaining to the amount, rate, and/or timing of backup power to be provided to the loads 316, sequence of delivery of backup power to the loads 316, charge status of the shared backup power supply 302, output status of the shared backup power supply 302, and the like.

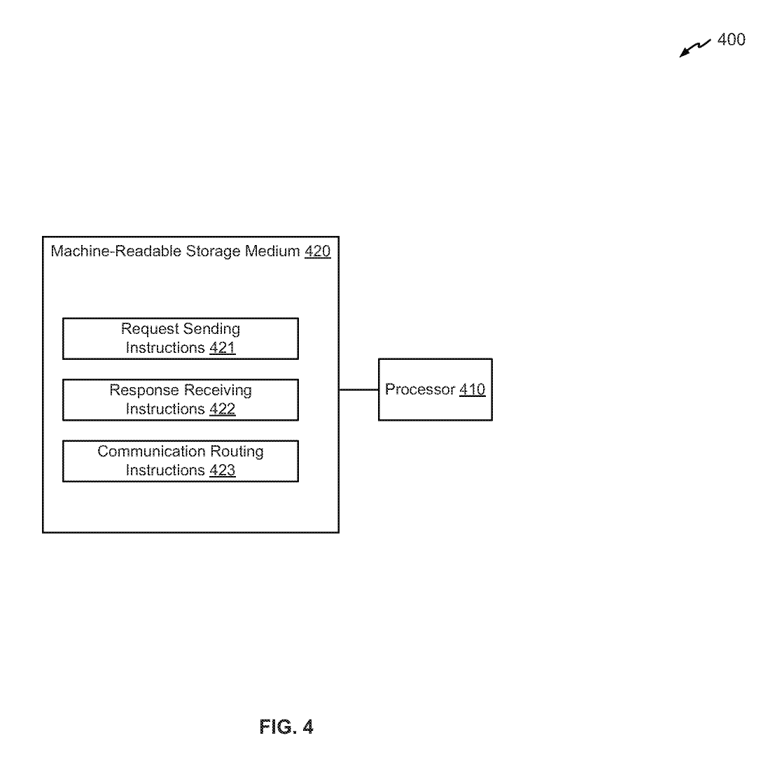

FIG. 4 is a block diagram of a computer-readable storage medium having instructions executable by a processor to facilitate P2P communication between a shared backup power supply and a plurality of loads, according to an example. Server node 400 includes machine-readable storage medium 420. Machine-readable storage medium 420 includes instructions 421, 422, and 423 executable by a processor 410 to perform the functionalities described herein.

Request sending instructions 421 include instructions to send a request from a shared backup power to a plurality of loads of a node using a P2P communication protocol. For example, using the P2P communication protocol, the shared backup power supply can communicate with the loads to determine that particular loads are to be protected with backup power supply from the shared backup power supply. The determination can enable configuration of the loads. It should be noted that in certain examples, requests can be sent from the loads to the shared backup power supply using the P2P communication protocol.

Response receiving instructions 422 include instructions to receive, by the shared backup power supply, a response from the plurality of loads using the P2P communication protocol, the response identifying a subset of the plurality of loads that are to be protected by the shared backup power supply. For example, the shared backup power supply can receive a response indicating a subset of the loads to be protected with backup power, where the communication is via P2P. It should be noted that responses can also be received by the loads using P2P communication protocol.

Communication routing instructions 423 include instructions to route the communication between the shared backup power supply and the plurality of loads via a CPU of the node. In such an example, the CPU supports the P2P communication protocol. As described above, the communication includes activity and status information of the shared backup power supply and the loads.

The techniques described above may be embodied in a computer-readable medium for configuring a computing system to execute the method. The computer-readable media may include, for example and without limitation, any number of the following non-transitive mediums: magnetic storage media including disk and tape storage media; optical storage media such as compact disk media (e.g., CD-ROM, CD-R, etc.) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, etc.; and the Internet, just to name a few. Other new and obvious types of computer-readable media may be used to store the software modules discussed herein. Computing systems may be found in many forms including but not limited to mainframes, minicomputers, servers, workstations, personal computers, notepads, personal digital assistants, tablets, smartphones, various wireless devices and embedded systems, just to name a few.

In the foregoing description, numerous details are set forth to provide an understanding of the present disclosure. However, it will be understood by those skilled in the art that the present disclosure may be practiced without these details. While the present disclosure has been disclosed with respect to a limited number of examples, those skilled in the art will appreciate numerous modifications and variations therefrom. It is intended that the appended claims cover such modifications and variations as fall within the true spirit and scope of the present disclosure.

What is claimed is:

1. A system, comprising:
a shared backup power supply coupled to a node, wherein the shared backup power supply includes a first communication interface; and
a plurality of loads supported by the node, wherein each load of the plurality of loads includes a second communication interface,
the first and second communication interfaces to support peer-to-peer (P2P) communication between the shared backup power supply and the plurality of loads.

2. The system of claim 1, comprising a central processing unit (CPU) of the node, the CPU to route the communication between the shared backup power supply and the plurality of loads.

3. The system of claim 1, wherein the first and second communication interfaces are peripheral component interconnect express (PCIe) interfaces.

4. The system of claim 1, wherein the second communication interface supports P2P communication among the plurality of loads.

5. The system of claim 1, wherein the communication includes status and activity information.

6. The system of claim 1, the shared backup power supply to provide backup power to the plurality of loads in response to an interruption of a primary power supply.

7. The system of claim 1, wherein the shared backup power supply includes a controller and wherein the controller includes the first communication interface.

8. The system of claim 1, wherein the plurality of loads each include a controller and wherein the controller includes the second communication interface.

9. The system of claim 1, wherein the plurality of loads includes an array controller and a storage device and wherein the storage device includes a dual in-line memory module (DIMM) and a non-volatile dual in-line memory module (NVDIMM).

10. A system comprising,
a shared backup power supply to provide backup power to a plurality of loads of a node, wherein the shared backup power supply includes a control module that includes a first communication interface; and
an array controller coupled to the plurality of loads, the array controller to manage the plurality of loads and wherein the array controller includes a second communication interface,
the first and second communication interfaces to support peer-to-peer (P2P) communication between the shared backup power supply and the plurality of loads.

11. The system of claim 10, wherein the first and second communication interfaces are peripheral component interconnect express (PCIe) interfaces.

12. The system of claim 10, wherein the first communication interface of the shared backup power supply and the second communication interface of the array controller are communicatively coupled to a central processing unit (CPU) of the node.

13. The system of claim 12, wherein the CPU supports P2P communication between the shared backup power supply and the plurality of loads and wherein the CPU supports P2P communication among the plurality of loads.

14. A non-transitory machine-readable storage medium encoded with instructions executable by a processor, the machine-readable storage medium comprising instructions to:
send a request from a shared backup power supply to a plurality of loads of a node using a peer-to-peer (P2P) communication protocol; and
receive, by the shared backup power supply, a response from the plurality of loads using the P2P communication protocol, the response identifying a subset of the plurality of loads that are to be protected by the shared backup power supply.

15. The non-transitory machine-readable storage medium of claim 14, comprising instructions to:
route the communication between the shared backup power supply and the plurality of loads via a central processing unit (CPU) of the node,
wherein the CPU supports P2P communication between the shared backup power supply and the plurality of loads, and
wherein the communication includes activity and status information of the shared backup power supply and the plurality of loads.
